(19) United States
(12) Patent Application Publication
(10) Pub. No.: US 2005/0054352 A1
(43) Pub. Date: Mar. 10, 2005

(54) Introduction system and method utilizing mobile communicators

(76) Inventor: Gyora Karaizman, Cesarea (IL)

Correspondence Address: Ladas & Parry, 26 West 61st Street, New York, NY, 10023, US

(21) Appl. No.: 10/657,352

(22) Filed: Sep. 8, 2003

(51) Int. Cl. H04Q 7/20; H04M 11/00

(52) U.S. Cl. 455/456.3; 455/456.1

(57) ABSTRACT

An introductions system including a plurality of mobile communicators and a server communicating with the plurality of mobile communicators, the server being operative to store personal information relating to users of the plurality of mobile communicators and to provide to a first user of the users via the first user's mobile communicator, the personal information relating to a second user of the users, upon designation of the first user by the second user, using the second user's mobile communicator.

### FIELD OF THE INVENTION

The present invention relates to systems and methodologies for facilitating and establishing introductions between persons.

### BACKGROUND OF THE INVENTION

The following U.S. Patents are believed to represent the current state of the art:
U.S. Pat. Nos. 6,477,580; 6,112,181; 6,061,681 and 5,598,351.

### SUMMARY OF THE INVENTION

The present invention seeks to provide highly effective systems and methodologies for facilitating and establishing introductions between persons.

There is thus provided in accordance with a preferred embodiment of the present invention an introductions system including a plurality of mobile communicators and a server communicating with the plurality of mobile communicators, the server being operative to store personal information relating to users of the plurality of mobile communicators and to provide to a first user of the users via the first user's mobile communicator, the personal information relating to a second user of the users, upon designation of the first user by the second user, using the second user's mobile communicator.

In accordance with another preferred embodiment of the present invention the server is operative to provide the personal information generally in real time with respect to the designation.

In accordance with yet another preferred embodiment of the present invention the designation includes point-to-point short range wireless transmission from the mobile communicator of the second user to the mobile communicator of the first user. Alternatively, the designation includes employing a mobile communicator of the second user to photograph the first user, transmitting the photograph to the server, automatically recognizing the first user from the photograph and determining a mobile communicator address of the first user.

In accordance with still another preferred embodiment of the present invention the designation includes employing a mobile communicator location functionality for providing a map indicating the relative locations of a plurality of the mobile communicator in a space, employing the mobile communicator of the second user to receive the map and to designate the location on the map of the first user and determining a mobile communicator address of the first user.

In accordance with another preferred embodiment of the present invention the plurality of mobile communicators includes at least one cellular telephone. Additionally or alternatively, the plurality of mobile communicators includes at least one wireless personal digital assistant (PDA).

In accordance with yet another preferred embodiment of the present invention the server is operative to determine if the first person is a subscriber to the introductions system.

There is also provided in accordance with another preferred embodiment of the present invention an introductions system including a plurality of mobile communicators suitable for use by a corresponding plurality of users, each of the plurality of mobile communicators being operative to store personal information relating to a user thereof, the user being a first user of the plurality of users, and to transmit the personal information to a second user of the plurality of users via the second user's mobile communicator, upon designation of the second user by the first user, using the first user's mobile communicator.

Preferably, the personal information is transmitted generally in real time with respect to the designation. Additionally or alternatively, the designation includes point-to-point short range wireless transmission from the mobile communicator of the second user to the mobile communicator of the first user. In accordance with a preferred embodiment of the present invention the short range wireless transmission includes a transmission via a Bluetooth connection. Alternatively or additionally, the short range wireless transmission includes a transmission via a WLAN connection.

In accordance with yet another preferred embodiment of the present invention the plurality of mobile communicators includes at least one cellular telephone. Additionally or alternatively, the plurality of mobile communicators includes at least one wireless personal digital assistant (PDA).

In accordance with still another preferred embodiment of the present invention the mobile communicator is operative to determine if the second user is a subscriber to the introductions system.

There is yet further provided in accordance with yet another preferred embodiment of the present invention an introductions method including storing personal information relating to a plurality of users of a corresponding plurality of mobile communicators and providing to a first user of the plurality of users, via the first user's mobile communicator, the personal information of a second user of the plurality of users, upon the second user designating the first user by using the second user's mobile communicator.

In accordance with another preferred embodiment of the present invention the providing the personal information includes providing the personal information generally in real time with respect to the designating.

In accordance with yet another preferred embodiment of the present invention the designating includes wirelessly transmitting via a point-to-point short range wireless transmission from the mobile communicator of the second user to the mobile communicator of the first user. Additionally, the wirelessly transmitting includes transmitting via a Bluetooth connection. Alternatively or additionally, the wirelessly transmitting includes transmitting via a WLAN connection.

In accordance with still another preferred embodiment of the present invention the designating includes employing the second user's mobile communicator to photograph the first user, transmitting the photograph to a server, automatically recognizing the first user from the photograph and determining a mobile communicator address of the first user.

In accordance with another preferred embodiment of the present invention the designating includes employing a mobile communicator location functionality for providing a map indicating the relative locations of a plurality of the mobile communicator in a space, employing the second user's mobile communicator to receive the map, designating the location on the map of the first user and determining a mobile communicator address of the first user.

Preferably, the plurality of mobile communicators includes at least one cellular telephone. Additionally or alternatively, the plurality of mobile communicators includes at least one wireless personal digital assistant (PDA).

In accordance with yet another preferred embodiment of the present invention the method also includes determining if the first person is a subscriber to an introductions system.

### BRIEF DESCRIPTION OF THE DRAWINGS

The present invention will be understood and appreciated more fully from the following detailed description in which:

FIG. 1 is a simplified illustration of a generalized system and methodology for facilitating an introduction between persons in accordance with a preferred embodiment of the present invention utilizing visual recognition;

FIG. 2 is a simplified illustration of a generalized system and methodology for facilitating an introduction between persons in accordance with a preferred embodiment of the present invention utilizing point-to-point communication;

FIG. 3 is a simplified illustration of a generalized system and methodology for facilitating an introduction between persons in accordance with a preferred embodiment of the present invention utilizing point-to-point communication and camera functionality for aiming;

FIG. 4 is a simplified illustration of a generalized system and methodology for facilitating an introduction between persons in accordance with a preferred embodiment of the present invention utilizing location mapping employing cellular location functionality;

FIG. 5 is a simplified illustration of a generalized system and methodology for facilitating an introduction between persons in accordance with a preferred embodiment of the present invention utilizing location mapping employing GPS functionality;

FIG. 6 is a simplified flowchart illustrating the generalized system and methodology for facilitating an introduction between persons in accordance with a preferred embodiment of the present invention utilizing visual recognition illustrated in FIG. 1;

FIG. 7 is a simplified flowchart illustrating the generalized system and methodology for facilitating an introduction between persons in accordance with a preferred embodiment of the present invention utilizing point-to-point communication illustrated in FIG. 2;

FIG. 8 is a simplified flowchart illustrating the generalized system and methodology for facilitating an introduction between persons in accordance with a preferred embodiment of the present invention utilizing point-to-point communication and camera functionality for aiming illustrated in FIG. 3;

FIG. 9 is a simplified flowchart illustrating the generalized system and methodology for facilitating an introduction between persons in accordance with a preferred embodiment of the present invention utilizing location mapping employing cellular location functionality illustrated in FIG. 4; and

FIG. 10 is a simplified flowchart illustrating the generalized system and methodology for facilitating an introduction between persons in accordance with a preferred embodiment of the present invention utilizing location mapping employing GPS functionality illustrated in FIG. 5.

### DETAILED DESCRIPTION OF PREFERRED EMBODIMENTS

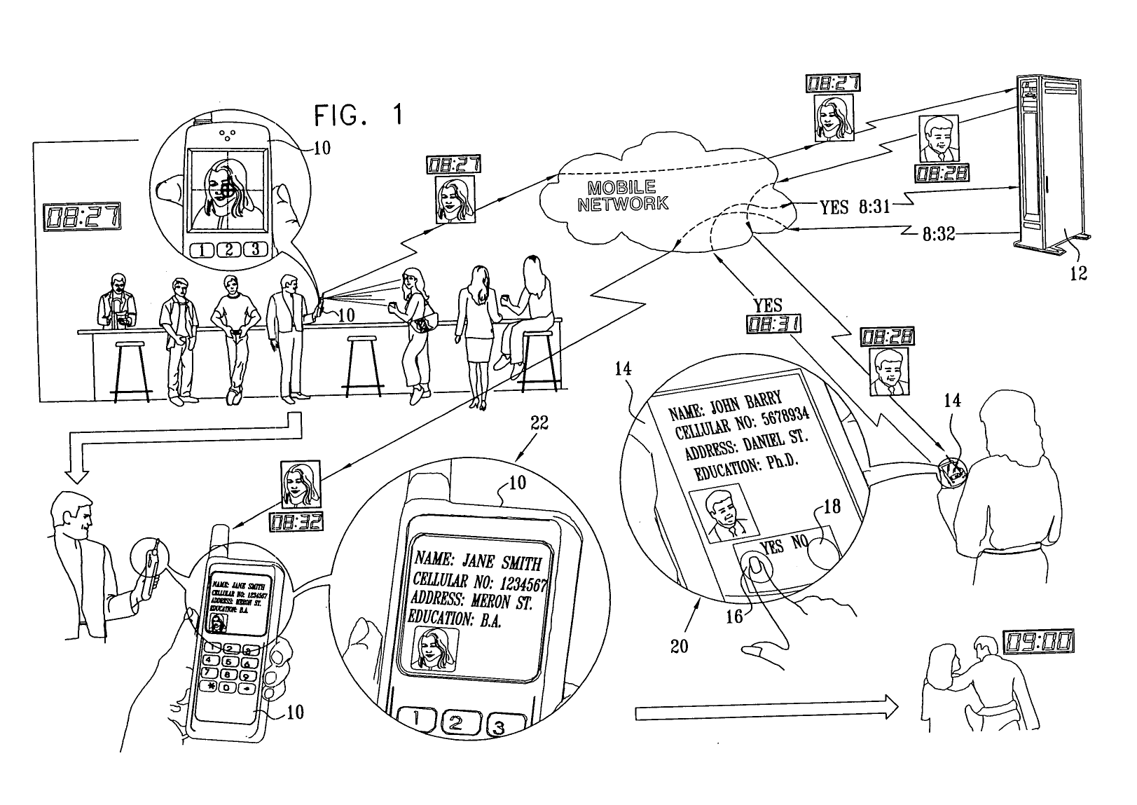

Reference is now made to FIG. 1, which is a simplified illustration of a generalized system and methodology for facilitating an introduction between persons in accordance with a preferred embodiment of the present invention utilizing visual recognition. As seen in FIG. 1, there is provided an introductions system and functionality which employs a plurality of mobile communicators, an example of which is a cellular telephone 10 having camera functionality, such as a model 3650, commercially available from Nokia Corporation, Keilalahdentie 2-4, P.O. Box 226, FIN-00045, Finland, a wireless PDA with camera functionality, such as a model PEG-NZ90, commercially available from Sony Corporation of Japan, or any other suitable mobile communicator.

In the illustrated embodiment, a person, hereinafter termed the “imaging person”, employs cellular telephone 10 to image another person, hereinafter termed the “imaged person”, and to transfer the image of the imaged person via a mobile network to a server 12, which typically communicates with a plurality of such mobile communicators.

Server 12 typically comprises a Facial Recognition Server, such as FaceVACS server, commercially available from Cognitec Systems GmbH, Dresden Headquarters, An der Flutrinne 12, D-01 139 Dresden, Germany, typically embodied in a plurality of separate physical servers.

Server 12 also preferably comprises a Personal Membership Details server, typically embodied in a conventional database software application, such as that commercially available from Oracle Corporation, 500 Oracle Parkway, Redwood Shores, Calif. 94065 USA. The Personal Membership Details server portion of server 12 is preferably operative to store personal information relating to certain users of the plurality of mobile communicators, who have earlier subscribed to the introductions system and functionality. Additionally, server 12 is operative to determine if the imaged person is a subscriber to the introductions system and functionality. If the imaged person is a subscriber to the introductions system, the server 12, using conventional facial recognition software, recognizes the imaged person and provides to the imaged person personal details stored at server 12 regarding the imaging person, such as for example, name, photograph, telephone number, address and education.

The imaged person may then decide whether to allow server 12 to provide personal details of the imaged person to the imaging person. This decision may typically be made by pressing on one or more buttons on a mobile communicator 14, held by the imaged person, such as buttons 16 and 18, having YES and NO functionalities respectively.

If the imaged person agrees to provide personal details to the imaging person, as illustrated in FIG. 1 at reference numeral 20, the server 12 provides such details to the imaging person, as indicated at reference numeral 22. In this way, an introduction between the persons is enabled.

It is appreciated that the functionality of server 12 may be embodied in one or more physical servers.

It is appreciated that the functionality described hereinabove may take place in real time or near real time, as illustrated, or alternatively may take place other than in real time.

It is appreciated that the mobile communicator, as part of its camera functionality, is typically provided with at least an image capture mode, an image storage mode, an image viewing mode and an image transmission mode. Additionally, the camera functionality preferably includes a zoom functionality.

In accordance with a preferred embodiment of the present invention, cellular telephone 10 and mobile communicator 14 are provided with functionality required to enable the transactions described hereinabove. These functionalities may include, but are not limited to, an image capture and storage functionality, a stored image viewing functionality, a stored image transmission functionality, which preferably includes transmission via a wireless network, and a personal details sending and receiving functionality, preferably including a user selectable sending functionality.

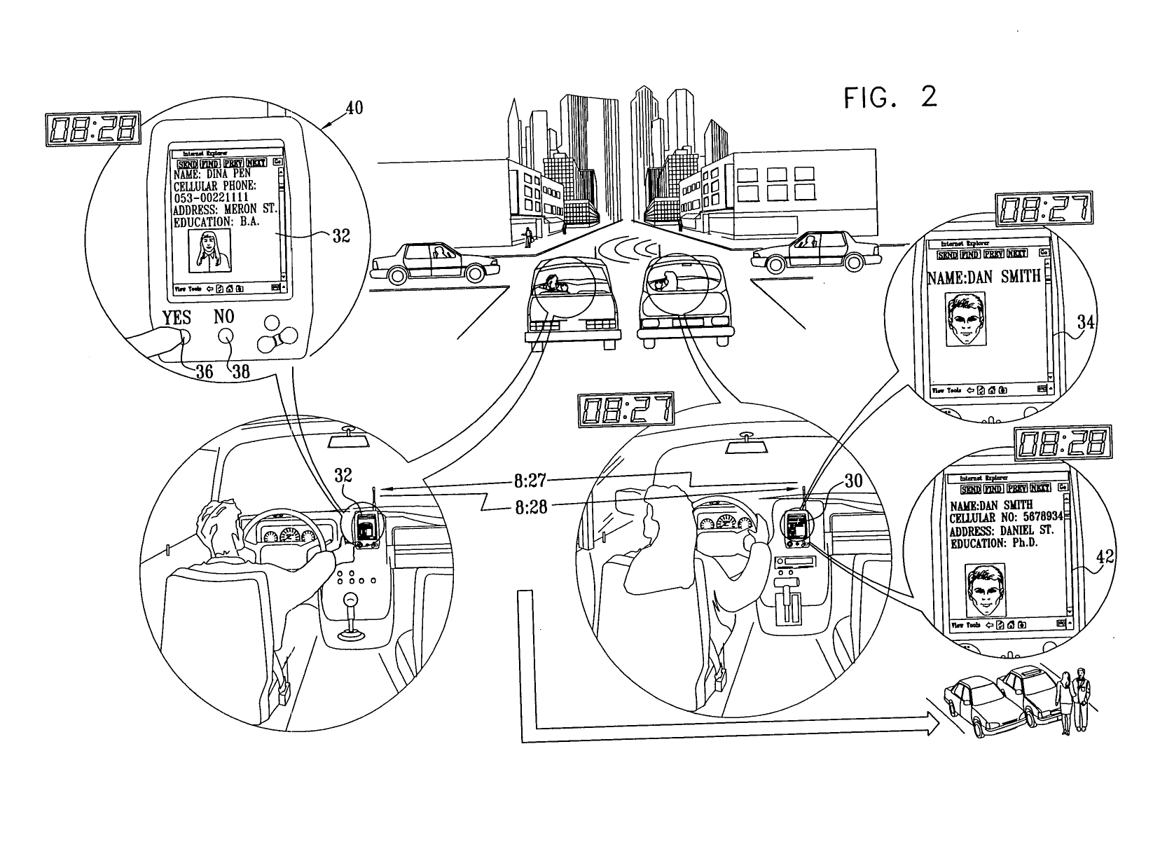

Reference is now made to FIG. 2, which is a simplified illustration of a generalized system and methodology for facilitating an introduction between persons in accordance with another preferred embodiment of the present invention utilizing point-to-point communication. As seen in FIG. 2, there is provided an introductions system and functionality which employs a plurality of mobile communicators, an example of which is a cellular telephone 30 having point-to-point communications functionality, such as a model T610, commercially available from Sony Ericsson Mobile Communications, Sony Ericsson House, 202 Hammersmith Road, London W67DN, UK, a wireless PDA having point-to-point communications functionality, such as a model SPT 1800, commercially available from Symbol Technologies Asia, Inc., 230 Victoria Street #05-07/09, Bugis Junction Office Tower, Singapore, or any other suitable mobile communicator.

In the illustrated embodiment, a person, hereinafter termed the “initiating person”, employs cellular telephone 30 to establish point-to-point communication with a cellular telephone 32 of another person, hereinafter termed the “contacted person” and to transfer personal information of the initiating person, stored in cellular telephone 30, such as for example, name, photograph and telephone number, via the point-to-point connection to the contacted person.

Communication with the desired contacted person typically involves wirelessly communicating via a Bluetooth connection, WLAN connection or other suitable wireless connection. A communication link is typically established by the initiating person receiving a list of subscribers to the introduction system within a communication range. The initiating person is then able to search the list, using conventional search methods, to select a subscriber.

The mobile communicator of the selected subscriber is preferably operative to provide an acknowledgement and other additional information, such as a picture, to cellular telephone 30, as illustrated in FIG. 2 at reference numeral 34. The initiating person is then able to use the point-to-point connection to provide personal details, stored in wireless telephone 30, to the contacted person via cellular telephone 32.

The contacted person may then decide whether to provide their personal details to the initiating person. This decision may typically be made by pressing on one or more buttons on cellular telephone 32, such as buttons 36 and 38, having YES and NO functionalities, respectively.

If the contacted person agrees to provide personal details to the initiating person, as illustrated in FIG. 2 at reference numeral 40, such details are received by the initiating person, as indicated at reference numeral 42. In this way, an introduction between the persons is enabled.

It is appreciated that the functionality described hereinabove may take place in real time or near real time, as illustrated, or alternatively may take place other than in real time.

In accordance with a preferred embodiment of the present invention, cellular telephone 30 and cellular telephone 32 are provided with the required functionality to enable the transactions described hereinabove. These functionalities may include, but are not limited to, a personal details storage functionality, a wireless send/receive functionality, a search functionality and a personal details sending and receiving functionality, preferably including a user selectable sending functionality.

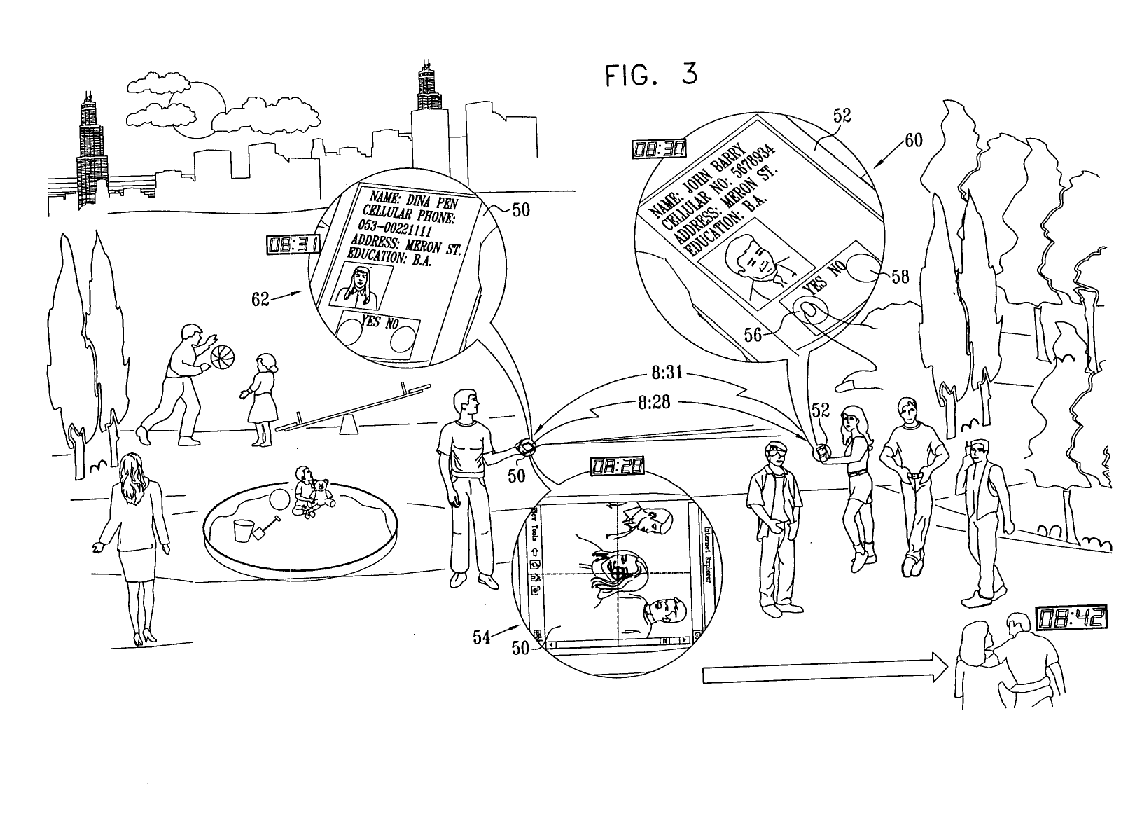

Reference is now made to FIG. 3, which is a simplified illustration of a generalized system and methodology for facilitating an introduction between persons in accordance with another preferred embodiment of the present invention utilizing point-to-point communication. As seen in FIG. 3, there is provided an introductions system and functionality which employs a plurality of mobile communicators, such as a wireless PDA 50 having point-to-point communications functionality, such as a model SPT 1800, commercially available from Symbol Technologies Asia, Inc., 230 Victoria Street #05-07/09, Bugis Junction Office Tower, Singapore, a cellular telephone having point-to-point communications functionality or any other suitable mobile communicator.

In the illustrated embodiment, a person, hereinafter termed the “imaging person” employs wireless PDA 50 to establish point to point communication with a similar wireless PDA 52 of another person, hereinafter termed the “contacted person”, and to transfer personal information of the imaging person, stored in wireless PDA 50, such as for example, name, photograph and telephone number, via the point-to-point connection to the contacted person. Establishment of communication with the desired contacted person typically involves positioning the wireless PDA 50, as illustrated in FIG. 3 at reference numeral 54, so that the contacted person is seen on a display of the PDA by means of a camera incorporated therein.

If the contacted person is a subscriber to the introductions system, the wireless PDA 52 of the contacted person is preferably operative to send an acknowledgement to wireless PDA 50, notifying the imaging person that the contacted person is a subscriber. The imaging person is then able to use the point-to-point connection to provide personal details, stored in wireless PDA 50, to the contacted person.

The contacted person may then decide whether to provide personal details of the contacted person to the imaging person. This decision may typically be made by pressing on one or more buttons on wireless PDA 52, such as buttons 56 and 58, having YES and NO functionalities, respectively.

If the contacted person agrees to provide personal details to the imaging person, as illustrated in FIG. 3 at reference numeral 60, such details are received by the contacted person, as indicated at reference numeral 62. In this way, an introduction between the persons is enabled.

It is appreciated that the functionality described hereinabove may take place in real time or near real time, as illustrated, or alternatively may take place other than in real time.

In accordance with a preferred embodiment of the present invention, wireless PDA 50 and wireless PDA 52 are provided with functionality required to enable the transactions described hereinabove. These functionalities may include, but are not limited to, an image capture functionality, a personal details storage functionality, an acknowledgement sending and receiving functionality and a personal details sending and receiving functionality, preferably including a user selectable sending functionality.

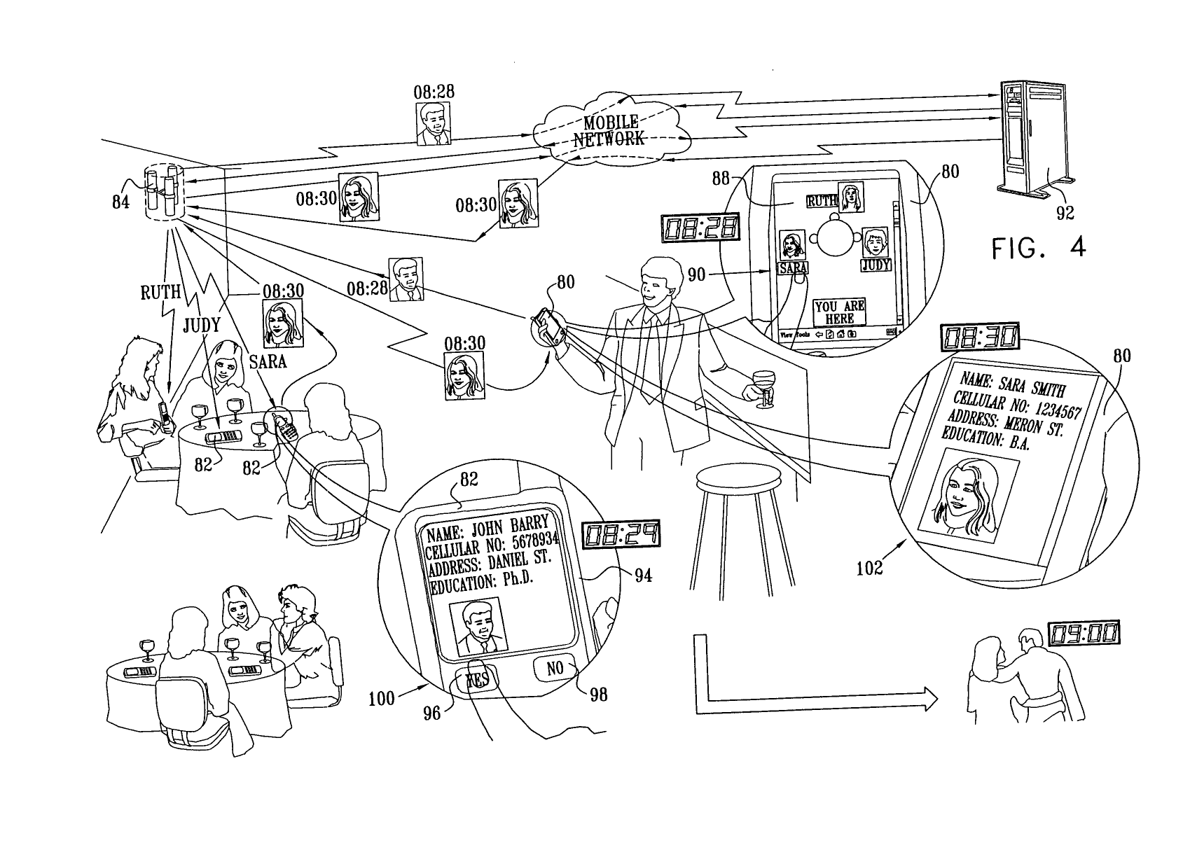

Reference is now made to FIG. 4, which is a simplified illustration of a generalized system and methodology for facilitating an introduction between persons in accordance with a preferred embodiment of the present invention utilizing location mapping.

As seen in FIG. 4, there is provided yet another embodiment of an introductions system and functionality which employs a plurality of mobile communicators, an example of which is a wireless PDA 80, such as a model PEG-NZ90, commercially available from Sony Corporation of Japan, cellular telephones 82, such as model 3650 commercially available from Nokia Corporation, Keilalahdentie 2-4, P.O. Box 226, FIN-00045, Finland or any other suitable mobile communicator. In the embodiment of FIG. 4, there is provided a conventional cellular microcell transceiver 84, which provides communication via at least one mobile network. The various cellular mobile communicators 80 and 82 communicate via the microcell transceiver 84 and the at least one mobile network. Microcell transceiver 84 stores current information as to the relative locations of the various cellular mobile communicators 80 and 82.

In the illustrated embodiment, a person, hereinafter termed the “selecting person”, employs wireless PDA 80 to receive a map, such as map 88, which indicates the location of the PDA 80 relative to the locations of the other cellular mobile communicators 82 which are in communication with the microcell transceiver 84 and who are subscribers to the introductions system and functionality. The selecting person selects a mobile communicator 82 of another such person, hereinafter termed the “selected person” by designating the location of that communicator 82 on the screen of wireless PDA 80, by using a stylus or his finger, as indicated at reference numeral 90.

In the illustrated embodiment, the selecting person employs PDA 80 to communicate his selection via the at least one mobile network to a server 92, which typically communicates with a plurality of such mobile communicators via the at least one mobile network.

Alternatively, the selecting person employs wireless PDA 80 to receive a list of subscribers to the introductions system, who are located within a serving range of the microcell transceiver 84, or within another suitably defined range, from server 92. Server 92 may also provide other additional subscriber information, such as a picture, to the selecting person. The selecting person is then able to search the list, using conventional search methods, to select an available subscriber and to communicate the selection to server 92.

Server 92 is preferably operative to store personal information relating to certain users of the plurality of mobile communicators, who have earlier subscribed to the introductions system and functionality. Server 92 preferably communicates with cellular microcell transceiver 84 to identify those mobile communicators that are subscribers to the introductions system and functionality. The server 92, using conventional location recognition software, identifies the selected person and provides to the selected person personal details stored at server 92 regarding the selecting person, such as for example, name, photograph, telephone number, address and education.

Server 92 preferably comprises a Personal Membership Details server embodied in a conventional database software application, such as that commercially available from Oracle Corporation, 500 Oracle Parkway, Redwood Shores, Calif. 94065 USA. Additionally, server 92 preferably comprises location recognition software, such as that commercially available from Toyota Communication Systems Co. LTD, NHK Nagoya Broadcasting Center Building 1-13-3 Higashi Sakura, Higashi-Ku Nagoya, Japan.

The selected person may then decide whether to allow server 92 to provide personal details of the selected person to the selecting person. This decision may typically be made by pressing on one or more buttons on a mobile communicator 94, held by the selected person, such as buttons 96 and 98, having YES and NO functionalities respectively.

If the selected person agrees to provide personal details to the selecting person, as illustrated in FIG. 4 at reference numeral 100, the server 92 provides such details to the selecting person, as indicated at reference numeral 102. In this way, an introduction between the persons is enabled.

It is appreciated that the functionality described hereinabove may take place in real time or near real time, as illustrated, or alternatively may take place other than in real time.

In accordance with a preferred embodiment of the present invention, mobile communicators 80 and 82 are provided with functionality required to enable the transactions described hereinabove. These functionalities may include, but are not limited to, a map requesting functionality, a map receiving and viewing functionality, a search functionality and a personal details sending and receiving functionality, preferably including a user selectable sending functionality.

In accordance with another preferred embodiment of the present invention, mobile communicators 80 and 82 are operative to communicate their location to server 92. In this embodiment, users of mobile communicators 80 and 82, upon arriving at a location, typically notify server 92 of their presence at that location. Server 92 is then operative to store their location information and to provide their location information to other subscribers without additional input from microcell transceiver 84. It is appreciated that mobile communicators 80 and 82 may be operative to communicate their arrival or departure from a location to server 92 either with or without user intervention.

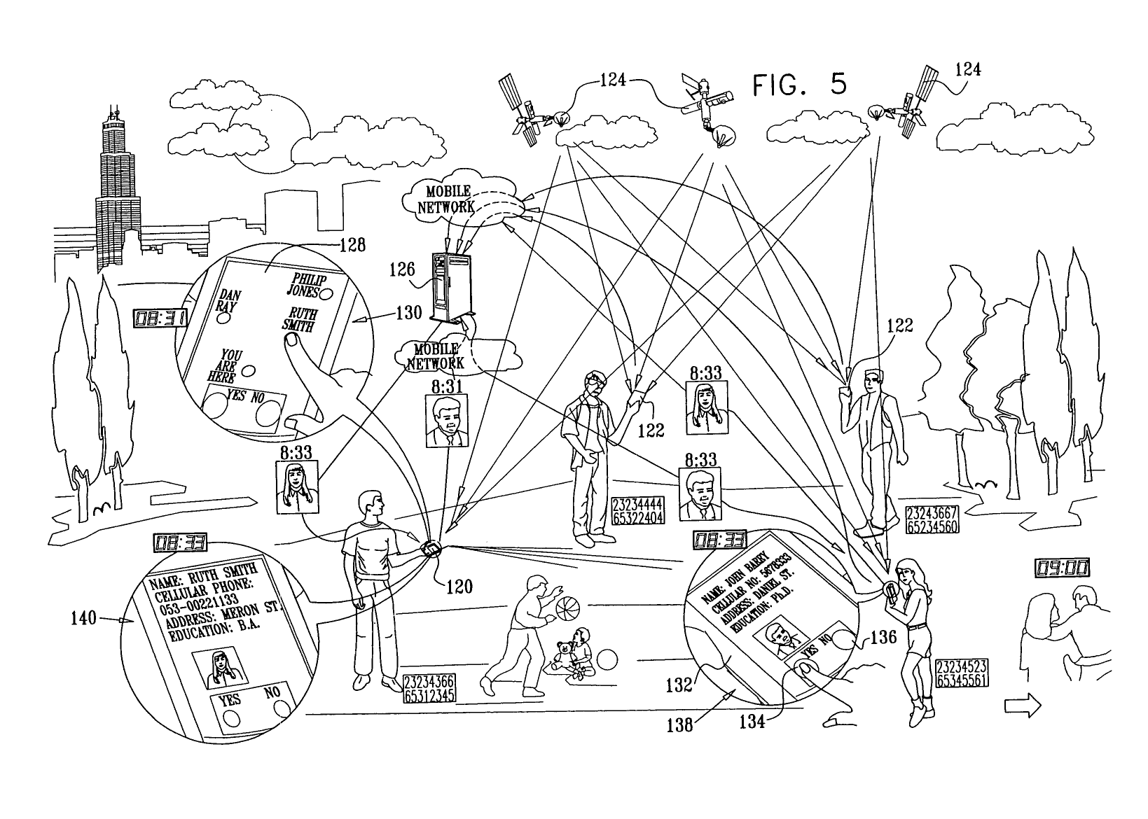

Reference is now made to FIG. 5, which is a simplified illustration of a generalized system and methodology for facilitating an introduction between persons in accordance with a further preferred embodiment of the present invention utilizing location mapping.

As seen in FIG. 5, there is provided another introductions system and functionality which employs a plurality of mobile communicators, an example of which is a wireless GPS equipped PDA 120, such as a model iQue™ 3600, commercially available from Garmin International Inc., 1200 E. 151^{st} Street, Olathe, Kans. 66062, USA, a GPS equipped cellular telephone 122, such as NavTalk GSM Phone/GPS, commercially available from Garmin International Inc., 1200 E. 151^{st} Street, Olathe, Kans. 66062, USA, or any other suitable mobile communicator. In the embodiment of FIG. 5, a conventional GPS satellite location system is assumed to exist and provides GPS data to the mobile communicators from at least three satellites 124. The various cellular mobile communicators 120 and 122 communicate via a mobile network with a server 126. Server 126 thus stores current information as to the relative locations of the various cellular mobile communicators 120 and 122.

In the illustrated embodiment, a person, hereinafter termed the “selecting person”, employs wireless PDA 120 to receive a map, such as map 128, which indicates the location of the PDA 120 relative to the locations of the other GPS equipped cellular mobile communicators 122 of subscribers to the introductions system and functionality. The selecting person selects a mobile communicator 122 of another such person, hereinafter termed the “selected person” by designating the location of that communicator 122 on the screen of PDA 120, by using a stylus or his finger, as indicated at reference numeral 130.

In the illustrated embodiment, the selecting person employs PDA 120 to communicate his selection via the mobile network to server 126, which typically communicates with a plurality of such mobile communicators via the mobile network.

Server 126 is preferably operative to store personal information relating to certain users of the plurality of mobile communicators, who have earlier subscribed to the introductions system and functionality. The server 126, using conventional location recognition software, identifies the selected person and provides to the selected person personal details stored at server 126 regarding the selecting person, such as for example, name, photograph, telephone number, address and education.

Server 126 preferably comprises a Personal Membership Details server embodied in a conventional database software application, such as that commercially available from Oracle Corporation, 500 Oracle Parkway, Redwood Shores, Calif. 94065 USA. Additionally, server 126 preferably comprises location recognition software, such as that commercially available from Toyota Communication Systems Co. LTD, NHK Nagoya Broadcasting Center Building 1-13-3 Higashi Sakura, Higashi-Ku Nagoya, Japan.

The selected person may then decide whether to allow server 126 to provide personal details of the selected person to the selecting person. This decision may typically be made by pressing on one or more buttons on a mobile communicator 132, held by the selected person, such as buttons 134 and 136, having YES and NO functionalities respectively.

If the selected person agrees to provide personal details to the selecting person, as illustrated in FIG. 5 at reference numeral 138, the server 126 provides such details to the selecting person, as indicated at reference numeral 140. In this way, an introduction between the persons is enabled.

It is appreciated that the functionality described hereinabove may take place in real time or near real time, as illustrated, or alternatively may take place other than in real time.

In accordance with a preferred embodiment of the present invention, mobile communicators 120, 122 and 132 are provided with functionality required to enable the transactions described hereinabove. These functionalities may include, but are not limited to, a map requesting functionality, a map receiving and viewing functionality and a personal details sending and receiving functionality, preferably including a user selectable sending functionality.

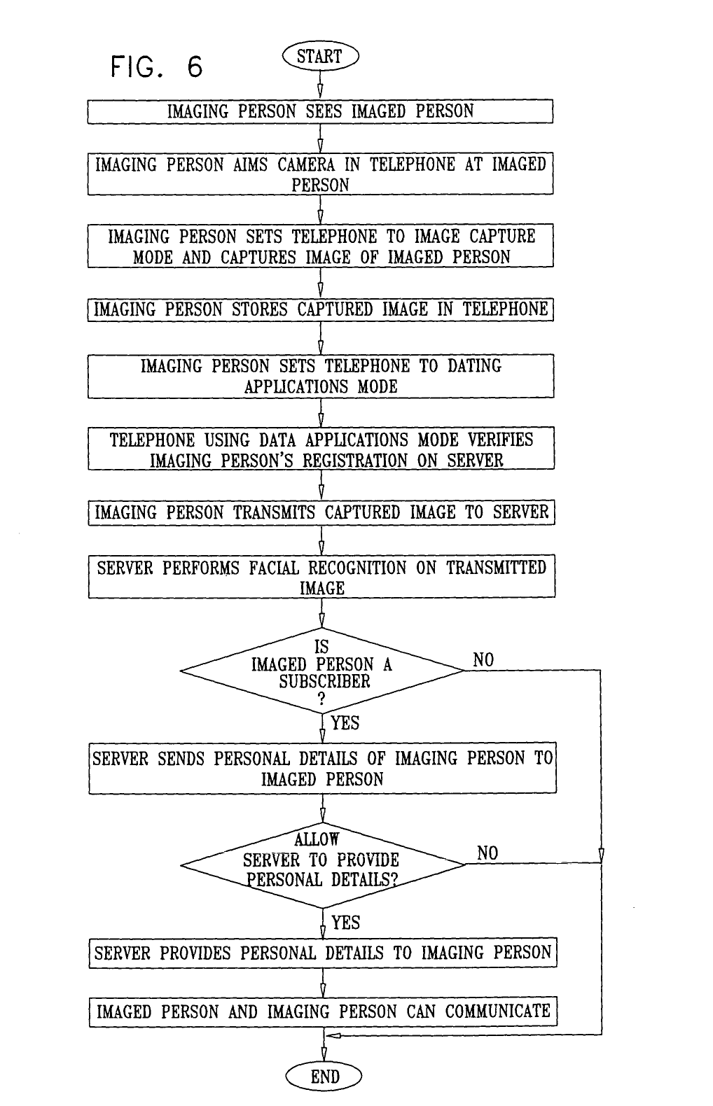

Reference is now made to FIG. 6, which is a simplified flowchart illustrating the generalized system and methodology for facilitating an introduction between persons in accordance with a preferred embodiment of the present invention utilizing visual recognition illustrated in FIG. 1.

As seen in FIG. 6, the imaging person sees the imaged person with whom he or she wishes to initiate communication. The imaging person turns on telephone 10 and aims the camera incorporated therein towards the imaged person. The imaging person operates the telephone 10 in an image capture mode, captures an image of the imaged person and stores the captured image. The imaging person then preferably operates telephone 10 in a dating applications mode, described hereinbelow, and, following verification of the imaging person's subscriber registration by server 12, transmits the captured image through the cellular network to server 12.

The dating applications mode preferably includes a set of functionalities that enable the telephone 10 to communicate with the server 12. These functionalities may include functionalities provided as part of the telephone 10, such as image transmission and receipt, that are customized for communicating with the server 12, and additional functionalities, such as subscriber registration verification and personal details sending and receiving functionality, that are provided to subscribers of the introductions system. This set of functionalities may also include additional display options to facilitate viewing the information received from server 12, and may also include custom input displays, for easy selection of options in response to requests from the server 12. These additional functionalities and customization may be implemented as a software addition or modification to the telephone 10. Alternatively, these functionalities and customization may be implemented in a device attached to the telephone 10 or any other suitable method.

As noted above, with reference to FIG. 1, server 12 preferably comprises a facial recognition server, which provides conventional facial recognition functionality, and a personal membership details server, providing personal information about subscribing members to the introductions system. Additionally, the personal membership details server of server 12 is operative to store the personal information about subscribing members to the introductions system and also includes functionality to enable it to identify a device transmitting a request for information and to determine if the transmitting device belongs to a subscribing member of the introductions system. The facial recognition functionality is also preferably operative to determine whether a person identified by the facial recognition functionality is a subscribing member of the introductions system.

As seen further in FIG. 6, server 12 then processes the transmitted image using the facial recognition functionality and determines if the imaged person is a subscribing member of the introductions system. If the imaged person is a subscribing member, server 12 is then operative to send the personal information of the imaging person to the imaged person. The imaged person then decides whether to allow server 12 to provide their personal information to the imaging person, and if the imaged person agrees server 12 then provides the personal information of the imaged person to the imaging person. The imaging person and the imaged person can then proceed to communicate with each other.

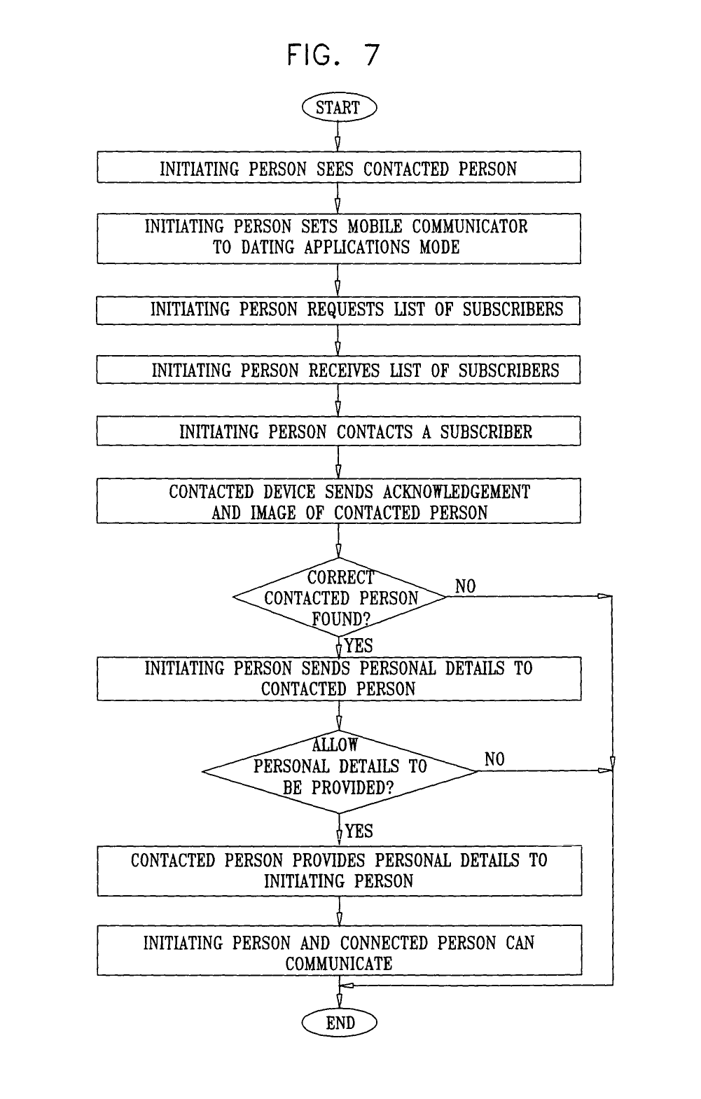

Reference is now made to FIG. 7, which is a simplified flowchart illustrating the generalized system and methodology for facilitating an introduction between persons in accordance with a preferred embodiment of the present invention utilizing point-to-point communication illustrated in FIG. 2.

As seen in FIG. 7, the initiating person sees the contacted person with whom he or she wishes to initiate communication. The initiating person turns on cellular telephone 30 in a dating applications mode, described hereinbelow, and communicates a request for a list of subscribers to the introductions system within a communication range of cellular telephone 30. The initiating person then receives the list of subscribers and searches the list to find the contacted person.

To locate the contacted person, the initiating person may use cellular telephone 30 to establish a wireless connection and to contact the cellular telephone of at least one of the subscribers via the wireless connection. The contacted cellular telephone sends an acknowledgement to cellular telephone 30 of the imaging person via the wireless connection. Additionally, the contacted cellular telephone preferably sends an image of the user thereof, for verification purposes, to the cellular telephone 30 of the imaging person.

Upon receiving the acknowledgement and verifying that the cellular telephone of the contacted person has been found, the initiating person then uses cellular telephone 30 to send his or her personal information, stored in cellular telephone 30, to the cellular telephone 32 of the contacted person. It is appreciated that in this embodiment subscribers to the introductions system have their subscriber information, an image and other personal information stored in a storage area of their mobile communicators.

The contacted person then decides whether to allow cellular telephone 32 to provide their personal information to the initiating person, and if the contacted person agrees cellular telephone 32 then provides the personal information of the contacted person to the cellular telephone 30 of the initiating person. The initiating person and the contacted person can then proceed to communicate with each other.

The dating applications mode preferably includes a set of functionalities that enable the cellular telephones 30 and 32 to communicate wirelessly, such as a Bluetooth connection or a WLAN connection, with other mobile communicators. These functionalities may include functionalities provided as part of the cellular telephones 30 and 32, such as image transmission and receipt, that are customized for communicating with other mobile communicators, and additional functionalities, such as subscriber registration verification and personal details sending and receiving functionality, that are provided to subscribers of the introductions system. This set of functionalities may also include additional display options, to facilitate viewing the information received via the wireless connection from other mobile communicators, and may also include custom input displays. These additional functionalities and customization may be implemented as a software addition or modification to the cellular telephones 30 and 32. Alternatively, these functionalities and customization may be implemented in a device attached to the cellular telephones 30 and 32 or any other suitable method.

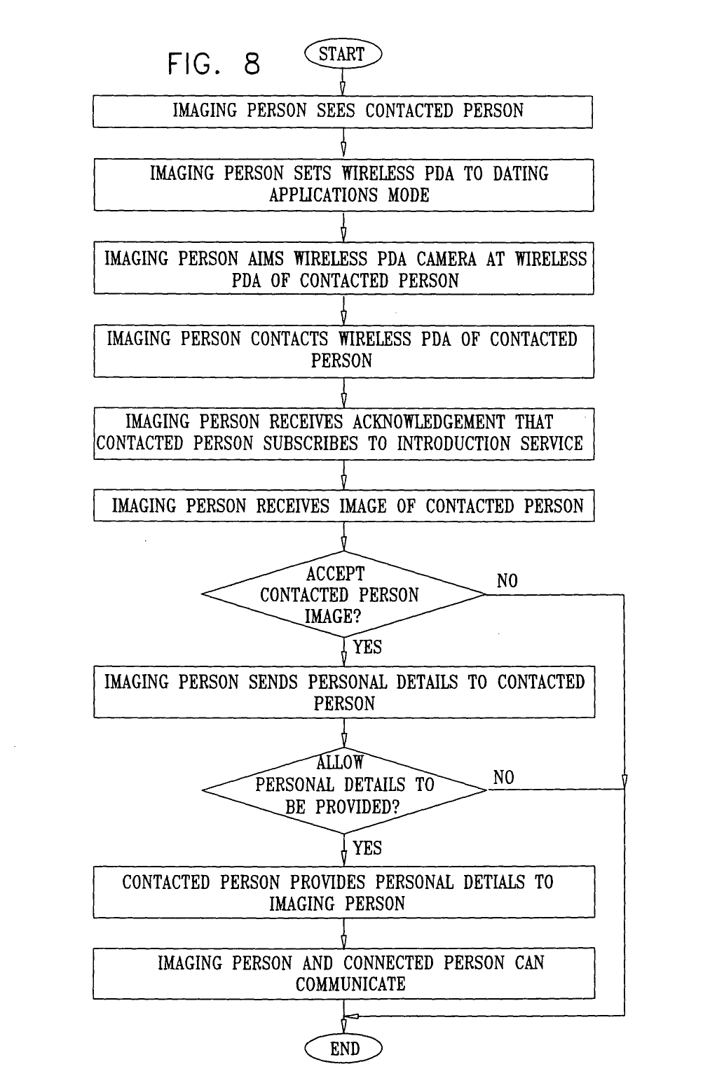

Reference is now made to FIG. 8, which is a simplified flowchart illustrating the generalized system and methodology for facilitating an introduction between persons in accordance with a preferred embodiment of the present invention, utilizing point-to-point communication and camera functionality for aiming, illustrated in FIG. 3.

As seen in FIG. 8, the imaging person sees the contacted person with whom he or she wishes to initiate communication. The imaging person turns on wireless PDA 50 in a dating applications mode, described hereinbelow, aims the camera of wireless PDA 50 at wireless PDA 52 of the contacted person and wirelessly communicates with the wireless PDA 52 of the contacted person. If the contacted person is a subscriber to the introductions system and functionality, the wireless PDA 52 of the contacted person sends an acknowledgement to wireless PDA 50 of the imaging person. Additionally, the wireless PDA 52 of the contacted person preferably sends an image of the contacted person, typically transmitted via a wireless connection such as a laser beam, to the wireless PDA 50 of the imaging person. Typically, in this embodiment, subscribers to the introductions system and functionality have their subscriber information, an image and other personal information stored on their mobile communicators.

The imaging person is then asked to verify that the image of the contacted person is the correct person. If the imaging person verifies the image, wireless PDA 50 is then operative to send personal information of the imaging person to the wireless PDA 52 of the contacted person. The contacted person then decides whether to allow wireless PDA 52 to provide their personal information to the imaging person, and if the contacted person agrees wireless PDA 52 then provides the personal information of the contacted person to the wireless PDA 50 of the imaging person. The imaging person and the contacted person can then proceed to communicate with each other.

The dating applications mode preferably includes a set of functionalities that enable the wireless PDAs 50 and 52 to communicate wirelessly with other mobile communicators. These functionalities may include functionalities provided as part of the wireless PDAs 50 and 52, such as image transmission and receipt, that are customized for communicating with other mobile communicators, and additional functionalities, such as subscriber registration verification and personal details sending and receiving functionality, that are provided to subscribers of the introductions system. This set of functionalities may also include additional display options, to facilitate viewing the information received via the wireless connection from other mobile communicators, and may also include custom input displays. These additional functionalities and customization may be implemented as a software addition or modification to the wireless PDAs 50 and 52. Alternatively, these functionalities and customization may be implemented in a device attached to the wireless PDAs 50 and 52 or any other suitable method.

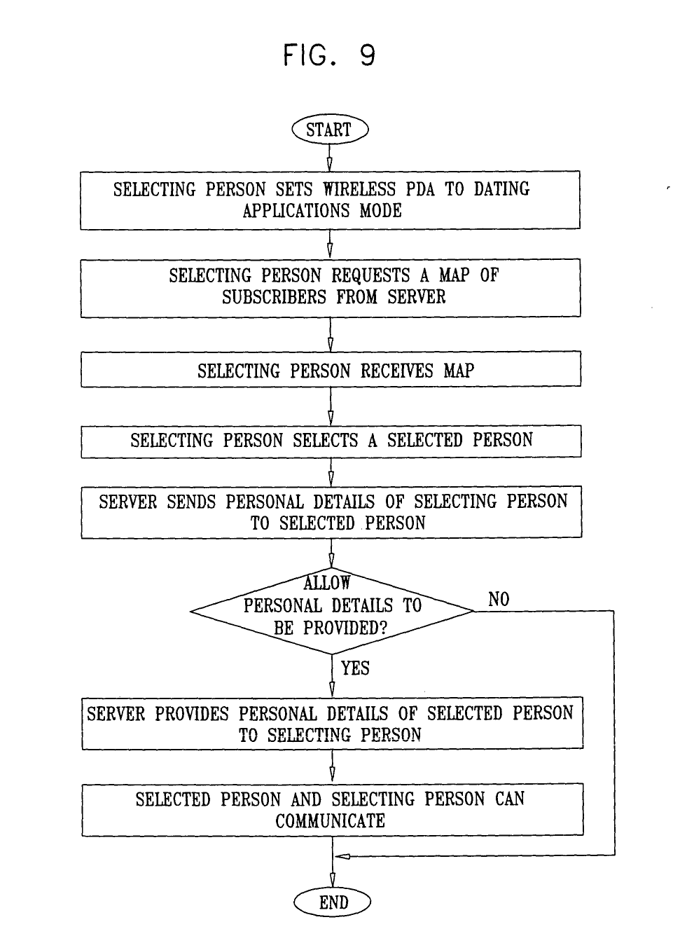

Reference is now made to FIG. 9, which is a simplified flowchart illustrating the generalized system and methodology for facilitating an introduction between persons in accordance with a preferred embodiment of the present invention, utilizing location mapping employing cellular location functionality, illustrated in FIG. 4.

As seen in FIG. 9, the selecting person turns on wireless PDA 80 in a dating applications mode, described hereinbelow, and requests a map indicating the location of mobile communicators 82 of subscribers to the introductions system and functionality. The selecting person then receives the map, which is preferably displayed on the screen of wireless PDA 80, from server 92 via microcell transceiver 84. The selecting person then preferably selects a selected person, typically by touching a location on the map on wireless PDA 80.

Wireless PDA 80 is then operative to send a request to server 92 to send the personal information of the selecting person to the communicator 82 of the selected person. The selected person then decides whether to provide their personal information to the selecting person, and if the selected person agrees communicator 82 then transmits a request to server 92 to provide the personal information of the selected person to the wireless PDA 80 of the selecting person. The selecting person and the selected person can then proceed to communicate with each other.

The dating applications mode preferably includes a set of functionalities that enable the wireless PDA 80 to communicate with the server 92. These functionalities may include functionalities provided as part of the wireless PDA 80, such as a list searching functionality, that are customized for communicating with the server 92, and additional functionalities, such as subscriber registration verification and personal details sending and receiving functionality, that are provided to subscribers of the introductions system. This set of functionalities may also include additional display options, to facilitate viewing the information received from server 92, such as a map display function, and may also include custom input displays, for easy selection of options in response to requests from the server 92. These additional functionalities and customization may be implemented as a software addition or modification to the wireless PDA 80. Alternatively, these functionalities and customization may be implemented in a device attached to the wireless PDA 80 or any other suitable method.

Additionally, server 92 preferably includes at least one of a location generating functionality and a map generating functionality, and is typically operative to communicate with microcell transceiver 84 to generate a list of subscribers who are located within the serving range of microcell transceiver 84. Alternatively, server 92 includes functionality to store location information received directly from mobile communicators 80 and 82 of subscribers to the introductions system.

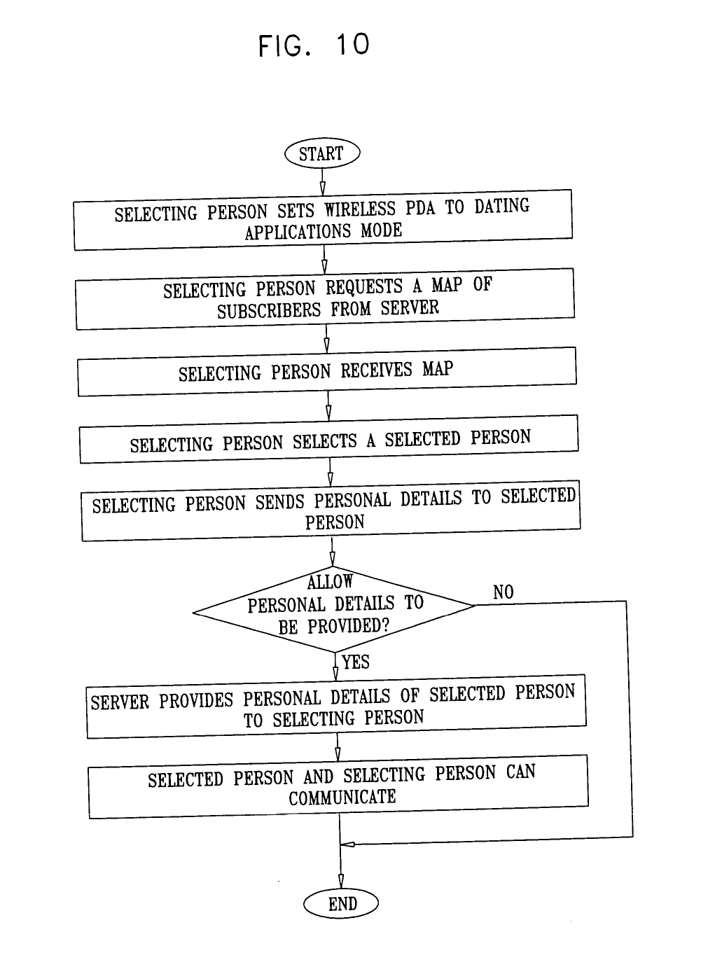

Reference is now made to FIG. 10, which is a simplified flowchart illustrating the generalized system and methodology for facilitating an introduction between persons in accordance with a preferred embodiment of the present invention utilizing location mapping employing GPS functionality.

As seen in FIG. 10, the selecting person turns on wireless PDA 120 in a dating applications mode, described hereinbelow, and requests a map indicating the location of mobile communicators 122 of subscribers to the introductions system and functionality. The selecting person then receives the map, which is preferably displayed on the screen of wireless PDA 120, from server 126. The selecting person then preferably selects a selected person, typically by touching a location on the map on wireless PDA 120.

Wireless PDA 120 is then operative to send a request to server 126 to send the personal information of the selecting person to the communicator 122 of the selected person. The selected person then decides whether to provide their personal information to the selecting person, and if the selected person agrees communicator 122 then transmits a request to server 126 to provide the personal information of the selected person to the wireless PDA 120 of the selecting person. The selecting person and the selected person can then proceed to communicate with each other.

The dating applications mode preferably includes a set of functionalities that enable the wireless PDA 120 to communicate with the server 126. These functionalities may include functionalities provided as part of the wireless PDA 120, that are customized for communicating with the server 126, and additional functionalities, such as subscriber registration verification and personal details sending and receiving functionality, that are provided to subscribers of the introductions system. This set of functionalities may also include additional display options, to facilitate viewing the information received from server 126, such as a map display function, and may also include custom input displays, for easy selection of options in response to requests from the server 126. These additional functionalities and customization may be implemented as a software addition or modification to the wireless PDA 120. Alternatively, these functionalities and customization may be implemented in a device attached to the wireless PDA 120 or any other suitable method.

Additionally, server 126 preferably includes at least one of a location generating functionality and a map generating functionality, and is typically operative to communicate with satellites 124 to generate a list of subscribers who are located within the range of PDA 120.

It is appreciated that, while the illustrated embodiments show communication between two cellular telephones or two PDAs, the present invention in not limited to communication between two like mobile communication devices. It is anticipated that the present invention may utilize any and all types of suitable mobile communication devices and operate with any and all suitable communication protocols.

It will be appreciated by persons skilled in the art that the present invention is not limited to what has been particularly shown and described hereinabove. Rather the scope of the present invention includes both combinations and subcombinations of the various features described hereinabove as well as modifications and variations thereof as would occur to a person of skill in the art upon reading the foregoing specification and which are not in the prior art.

1. An introductions system comprising:
a plurality of mobile communicators; and
a server communicating with said plurality of mobile communicators;
said server being operative to store personal information relating to users of said plurality of mobile communicators and to provide to a first user of said users via said first user's mobile communicator, said personal information relating to a second user of said users, upon designation of said first user by said second user, using said second user's mobile communicator.

2. An introductions system according to claim 1 and wherein said server is operative to provide said personal information generally in real time with respect to said designation.

3. An introductions system according to claim 1 and wherein said designation comprises point-to-point short range wireless transmission from said mobile communicator of said second user to said mobile communicator of said first user.

4. An introductions system according to claim 1 and wherein said designation comprises employing a mobile communicator of said second user to photograph said first user, transmitting said photograph to said server, automatically recognizing said first user from said photograph and determining a mobile communicator address of said first user.

5. An introductions system according to claim 1 and wherein said designation comprises employing a mobile communicator location functionality for providing a map indicating the relative locations of a plurality of said mobile communicator in a space, employing the mobile communicator of said second user to receive said map and to designate the location on said map of said first user and determining a mobile communicator address of said first user.

6. An introductions system according to claim 1 and wherein said plurality of mobile communicators comprises at least one cellular telephone.

7. An introductions system according to claim 1 and wherein said plurality of mobile communicators comprises at least one wireless personal digital assistant (PDA).

8. An introductions system according to claim 1 and wherein said server is operative to determine if said first person is a subscriber to said introductions system.

9. An introductions system comprising:
a plurality of mobile communicators suitable for use by a corresponding plurality of users, each of said plurality of mobile communicators being operative to store personal information relating to a user thereof, said user being a first user of said plurality of users, and to transmit said personal information to a second user of said plurality of users via said second user's mobile communicator, upon designation of said second user by said first user, using said first user's mobile communicator.

10. An introductions system according to claim 9 and wherein said personal information is transmitted generally in real time with respect to said designation.

11. An introductions system according to claim 9 and wherein said designation comprises point-to-point short range wireless transmission from said mobile communicator of said second user to said mobile communicator of said first user.

12. An introductions system according to claim 11 and wherein said short range wireless transmission comprises a transmission via a Bluetooth connection.

13. An introductions system according to claim 11 and wherein said short range wireless transmission comprises a transmission via a WLAN connection.

14. An introductions system according to claim 9 and wherein said plurality of mobile communicators comprises at least one cellular telephone.

15. An introductions system according to claim 9 and wherein said plurality of mobile communicators comprises at least one wireless personal digital assistant (PDA).

16. An introductions system according to claim 9 and wherein said mobile communicator is operative to determine if said second user is a subscriber to said introductions system.

17. An introductions method comprising:
storing personal information relating to a plurality of users of a corresponding plurality of mobile communicators; and
providing to a first user of said plurality of users, via said first user's mobile communicator, said personal information of a second user of said plurality of users, upon said second user designating said first user by using said second user's mobile communicator.

18. An introductions method according to claim 17 and wherein said providing said personal information comprises providing said personal information generally in real time with respect to said designating.

19. An introductions method according to claim 17 and wherein said designating comprises wirelessly transmitting via a point-to-point short range wireless transmission from said mobile communicator of said second user to said mobile communicator of said first user.

20. An introductions method according to claim 19 and wherein said wirelessly transmitting comprises transmitting via a Bluetooth connection.

21. An introductions method according to claim 19 and wherein said wirelessly transmitting comprises transmitting via a WLAN connection.

22. An introductions method according to claim 17 and wherein said designating comprises:
employing said second user's mobile communicator to photograph said first user;
transmitting said photograph to a server;
automatically recognizing said first user from said photograph; and
determining a mobile communicator address of said first user.

23. An introductions method according to claim 17 and wherein said designating comprises:
employing a mobile communicator location functionality for providing a map indicating the relative locations of a plurality of said mobile communicator in a space;
employing said second user s mobile communicator to receive said map;
designating the location on said map of said first user; and
determining a mobile communicator address of said first user.

24. An introductions method according to claim 17 and wherein said plurality of mobile communicators comprises at least one cellular telephone.

25. An introductions method according to claim 17 and wherein said plurality of mobile communicators comprises at least one wireless personal digital assistant (PDA).

26. An introductions method according to claim 17 and also comprising determining if said first person is a subscriber to an introductions system.
